(19) United States
(12) Patent Application Publication
(10) Pub. No.: US 2006/0248021 A1
(43) Pub. Date: Nov. 2, 2006

(54) Verification system using public records

(75) Inventors: Naveen K. Jain, Bellevue, WA (US); John K. Arnold, Des Moines, WA (US); Kevin R. Marcus, Woodinville, WA (US); Niraj Anil Shah, Mercer Island, WA (US)

Correspondence Address: MERCHANT & GOULD PC, P.O. BOX 2903, MINNEAPOLIS, MN, 55402-0903, US

(73) Assignee: Intelius, Bellevue, WA (US)

(21) Appl. No.: 11/285,748

(22) Filed: Nov. 22, 2005

Related U.S. Application Data
(60) Provisional application No. 60/630,136, filed on Nov. 22, 2004.

(51) Int. Cl. G06Q 99/00

(52) U.S. Cl. 705/75

(57) ABSTRACT

Public records are used to help in the detection and prevention of fraud as well as to verify a consumer. Public records are accessed in real-time and then used to determine if a consumer is who they claim to be or is a fraudster. Questions are generated using the public records based on an initial fraud score and a verification level associated with the entity requesting the fraud and verification services. Based on the response to the questions, the fraud score is updated and a confidence level is returned to the requestor to determine whether the user is legitimate or a fraudster. The questions may be presented online or offline. The verification can be different for every merchant.

### RELATED APPLICATIONS

This utility patent application claims the benefit under 35 United States Code § 119(e) of U.S. Provisional Patent Application No. 60/630,136 filed on Nov. 22, 2004, which is hereby incorporated by reference in its entirety.

### BACKGROUND OF THE INVENTION

Fraud has become pervasive throughout our society. Each year fraud complaints keep increasing in number. Just last year it was reported that there was over a sixty percent jump in complaints made to the Internet Fraud complaint center. The fraud is costing businesses and consumers a great deal of money. On the Internet alone the costs of fraud for consumers is in the hundreds of millions of dollars.

Most companies can not distinguish legitimate individuals and business from fraudsters. While fraud prevention technology exists to help eliminate some of the fraud, the technology can be too costly or time consuming for many companies to utilize.

### BRIEF DESCRIPTION OF THE DRAWINGS

FIG. 1 shows an exemplary fraud and verification system;

FIG. 2 shows an exemplary computing device;

FIG. 3 illustrates exemplary public records that may be accessed in order to verify a consumer;

FIG. 4 shows a process for detecting fraud and verifying a consumer using public records; and

FIG. 5 shows a process for calculating a fraud score and confidence level, in accordance with aspects of the invention.

### DETAILED DESCRIPTION OF THE PREFERRED EMBODIMENT

In the following detailed description of exemplary embodiments of the invention, reference is made to the accompanied drawings, which form a part hereof, and which is shown by way of illustration, specific exemplary embodiments of which the invention may be practiced. Each embodiment is described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

Generally, the present invention is related to using public records to help in the detection and prevention of fraud as well as to verify a consumer. Public records are accessed in real-time and then used to determine if a consumer is who they claim to be. Questions are generated using the public records based on an initial fraud score and a verification level associated with the entity requesting the fraud and verification services. Based on the response to the questions, the fraud score is updated and a confidence level is returned to the requestor to determine whether the user is legitimate or a fraudster. A legitimate user should be able to answer the questions within a predetermined amount of time. The questions may be presented online or offline. For example, a customer representative may ask the generated questions over the phone, in person, or in some other manner to a user being verified. The verification can be different for every merchant. For example, some merchants may want to be more demanding in the questions that they ask.

Illustrative Operating Environment

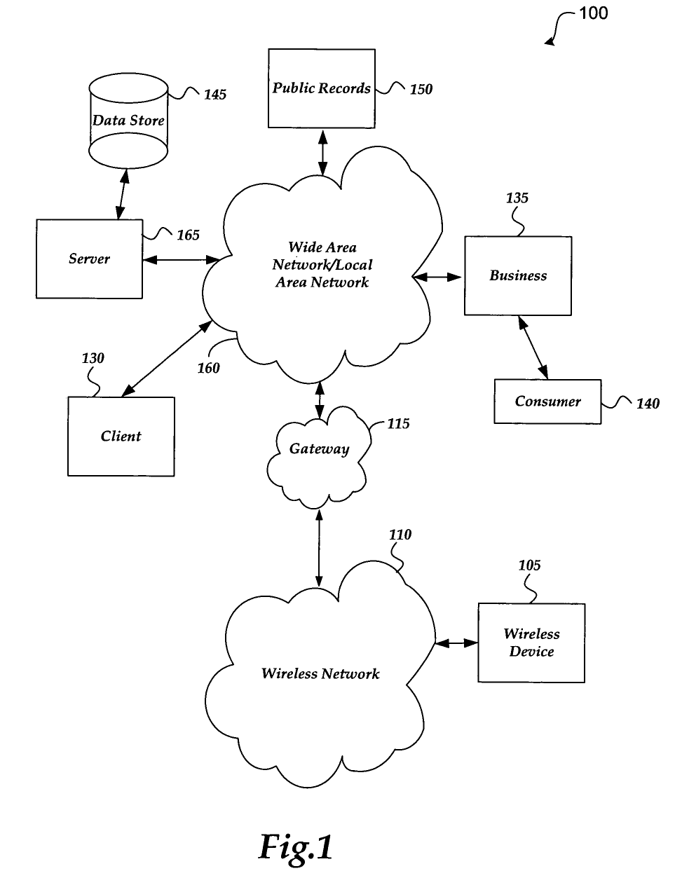

FIG. 1 shows an exemplary fraud and verification system, in accordance with aspects of the invention. As shown, fraud and verification system 100 includes wireless devices 105, wireless network 110, gateway 115, wide area network (WAN)/local area network (LAN) 160, client device 130, server 165, data store 145, business 135, consumer 140 and public records 150.

Generally, fraud and verification system 100 accesses public records 150, generates questions from the public records to verify a consumer, such as consumer 140, and provides a fraud score. The public records may be obtained from various sources, including from data store 145 and public records 150. Public records 150 typically are obtained from a wide variety of public record sources. For example, the public records may be obtained from address verification system (AVS) records; credit card verification system (CVV) records; death records; department of motor vehicle (DMV) records; social security records; property records; professional records; election contribution records; criminal records; marriage/divorce records; civil judgment records; Secretary of State records; as well as other public records.

Server 165 couples to WAN/LAN 160 through communication mediums and is configured to access public records 150 and perform operations relating to verifying a consumer, such as consumer 140, or a consumer using client 130 or wireless device 105. Server 165 is configured to generate verification questions for a consumer. The verification questions are generated based on an initial fraud score generated by verification system 100 as well as on a predetermined verification level. For example, the verification level may be categorized as low, medium, high, and the like. Questions for a low verification level are easier then verification questions that are generated for a high verification level. Server 165 is also configured to return an updated fraud score and a confidence level to client 130, wireless device 105, as well as business 135. These verifying entities may then use the confidence level and fraud score to determine whether or not to do business with the consumer.

Wireless device 105 couples to wireless network 110 and can include any device capable of connecting to a wireless network such as wireless network 110. Such devices include cellular telephones, smart phones, pagers, radio frequency (RF) devices, infrared (IR) devices, citizen band radios (CBs), integrated devices combining one or more of the preceding devices, and the like. Wireless device 105 may also include other devices that have a wireless interface such as PDAs, handheld computers, personal computers, multiprocessor systems, microprocessor-based or programmable consumer electronics, network PCs, and the like.

Wireless network 110 transports information to and from devices capable of wireless communication, such as wireless device 105. Wireless network 110 may include both wireless and wired components. For example, wireless network 110 may include a cellular tower linked to a wired telephone network. Typically, the cellular tower carries communication to and from cell phones, pagers, and other wireless devices, and the wired telephone network carries communication to regular phones, long-distance communication links, and the like.

Wireless network 110 couples to WAN/LAN through gateway 115. Gateway 115 routes information between wireless network 110 and WAN/LAN 200. For example, wireless device 105 may access network 160 using gateway 115. Gateway 115 may translate requests for web pages from wireless devices to hypertext transfer protocol (HTTP) messages, which may then be sent to WAN/LAN 160. Gateway 115 may then translate responses to such messages into a form compatible with the requesting device. Gateway 115 may also transform other messages sent from wireless devices 105 into information suitable for WAN/LAN 1600, such as purchase requests, e-mail, audio, voice communication, and the like.

Typically, WAN/LAN 160 transmits information between computing devices. One example of a WAN is the Internet, which connects millions of computers over a host of gateways, routers, switches, hubs, and the like. An example of a LAN is a network used to connect computers in a single office. A WAN may connect multiple LANs.

Client 130 couples to WAN/LAN 160 and includes any device capable of connecting to a data network, and is configured to receive and display household grouping information.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, communication media includes wired media such as twisted pair, coaxial cable, fiber optics, wave guides, and other wired media and wireless media such as acoustic, RF, infrared, and other wireless media.

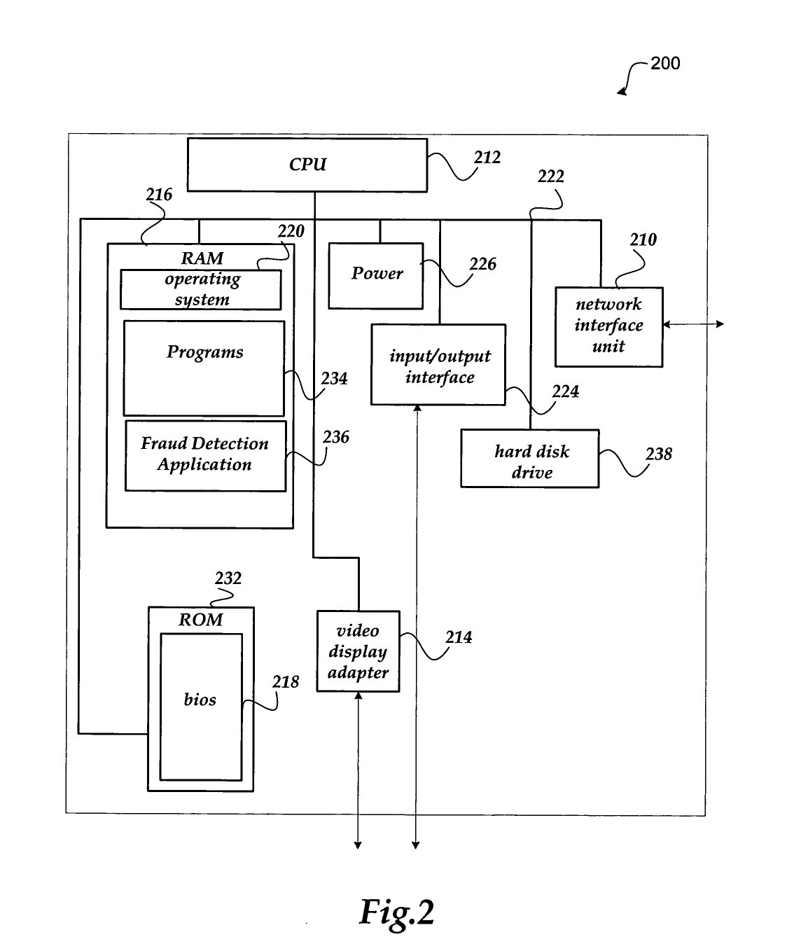

FIG. 2 shows an exemplary computing device, in accordance with aspects of the invention. Computing device 200 may be configured as a server, a client, or a wireless device as illustrated in FIG. 1.

Device 200 may transmit and receive data relating to verification. Device 200 may transmit information, such as WWW pages to a WWW browser application program executing on requesting devices (wireless device 105 and client 130) to display verification information. For instance, server 165 displayed in FIG. 1 may transmit pages and forms for presenting and receiving answers to verification questions related to verifying a consumer. The transactions may take place over the Internet, WAN/LAN 200, or some other communications network.

Computing device 200 may include many more components than those shown in FIG. 2. However, the components shown are sufficient to disclose an illustrative embodiment for practicing the present invention.

As shown in FIG. 2, computing device may connect to WAN/LAN 160, wireless network 110, or other communications network, via network interface unit 210. Network interface unit 210 may be wired or wireless, and includes the necessary circuitry for connecting computing device 200 to the desired network, and is constructed for use with various communication protocols including the TCP/IP protocol. Typically, network interface unit 210 is a card contained within computing device 200. Network interface unit 210 may include a radio layer (not shown) that is arranged to transmit and receive radio frequency communications. Network interface unit 210 connects computing device 200 to external devices, via a communications carrier or service provider.

Computing device 200 also includes central processing unit 212, video display adapter 214, and a mass memory, all connected via bus 222. The mass memory generally includes RAM 216, ROM 232, and one or more permanent mass storage devices, such as hard disk drive 238, a tape drive, CD-ROM/DVD-ROM drive, and/or some other drive. The mass memory stores operating system 220 for controlling the operation of computing device 200. This component may comprise a general purpose server operating system, such as UNIX, LINUX™, Microsoft WINDOWS XP®, and the like. Basic input/output system (“BIOS”) 218 is also provided for controlling the low-level operation of computing device 200.

The mass memory also stores program code and data. More specifically, the mass memory stores applications including programs 234, and fraud detection program 236. Generally, fraud detection program 236 is used to perform operations relating to verifying a consumer. Programs 234 may include computer executable instructions which, when executed by computing device 200, generate WWW browser displays, including performing the logic described above.

Computing device 200 may also comprises input/output interface 224 for communicating with external devices, such as a mouse, keyboard, scanner, or other input devices not shown in FIG. 2. Hard disk drive 238 is utilized by computing device 200 to store, among other things, application programs, databases, and program data used by household grouping program 236. For example, augmented records, public records, customer records, and relational databases may be stored.

Power supply 226 provides power to computing device 200. According to one embodiment, a rechargeable battery provides power. The power may be also be provided by an external power source, such as an AC adapter or a powered docking cradle that supplements or recharges a battery.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

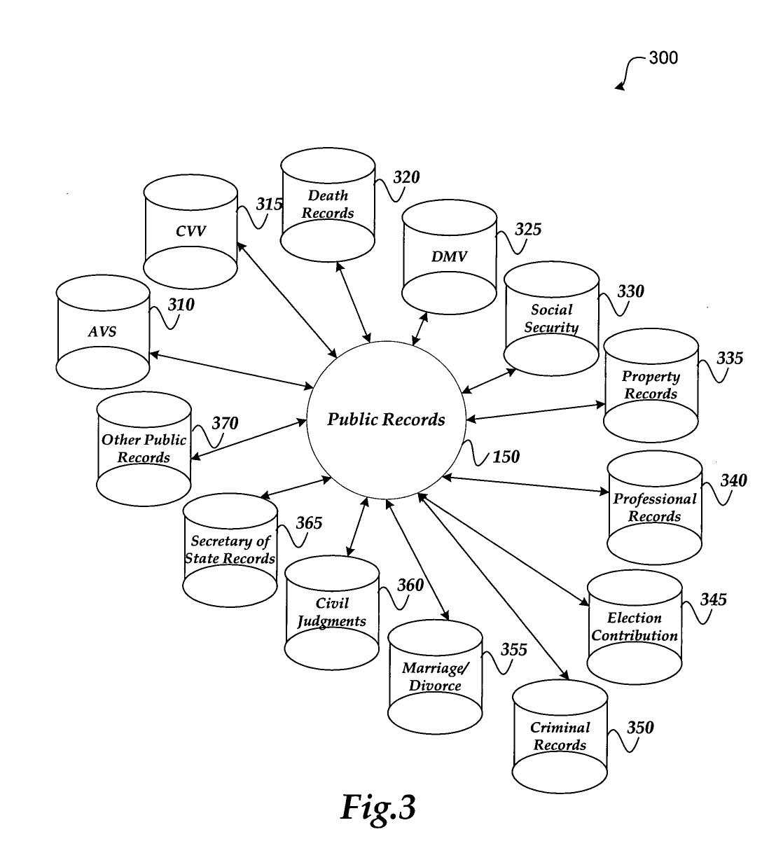

FIG. 3 illustrates exemplary public records that may be accessed in order to verify a consumer, in accordance with aspects of the invention. Generally, public records 300 may include any available public records that may be used in verifying a user. Public records selector 150 is configured to access various public record sources. As illustrated, public records 300 includes: address verification system (AVS) records 310; credit card verification system (CVV) records 315; death records 320; department of motor vehicle (DMV) records 325; social security records 330; property records 335; professional records 340; election contribution records 345; criminal records 350; marriage/divorce records 355; civil judgment records 360; Secretary of State records 365; and other public records 370. While some public records have no restrictions with their use, other public records are restricted in their use. The appropriate safeguards are used when accessing the various public records described within this document.

AVS records 310 is an address verification system provided by credit card companies that attempts to verify a consumer's credit card. A consumer's address is compared to what the credit card company has on file for the credit card. Generally for each inquiry, the requesting party may receive one of three responses. These include: match (varying level), no match, and not supported (all international banks). Generally the AVS system does not work for international card holders.

CVV records 315 is an anti-fraud security feature to help verify that the consumer attempting to use a credit card is actually in possession of the credit card. The CVV number is only stored on the card itself so the user has to have access to the card in order to be able to provide the number.

Birth/Death records 320 generally include information relating to the birth or death of an individual. The birth records may include the name of the parents, the location where born, the address of the parents, the date of the birth and the name at birth. The death records may include the name, age, social security number, and age of the deceased. A few exemplary questions that may asked, include: Where were you born? How old are you? What is one of your parent's name? and What is your birth date? Questions may be presented in any type of form. For example, the questions may be multiple choice, or require the user to respond with a specific answer to the question.

DMV records 325 generally include two different sets of records, including the tag file and the license file. The tag file generally includes the license plate number, owner of the vehicle, model, make, and vehicle identification number (VIN). The license file generally includes driver license number, name, address, city, state, zip, weight, type of license, eye color, height, and weight. Some exemplary questions that may be asked from DMV records 325 include: What kind of car do you drive? What is the year of the car? What is the license plate number? What is your driver's license number? and, How tall are you?

Social Security records 330 include an individual's social security number along with an address history, maiden name, as well as other information. Some exemplary questions may include: What are the last four digits of your social security number? What was your maiden name? and What was your previous address?

Property records 335 generally include an address, legal description, property and dwelling description, purchase date and price, mortgage information, previous owner, valuation information, and property taxes. Some exemplary questions include: Who are your neighbors? What is the purchase price of your house? When did you purchase your house? What is your mortgage payment? and How many bedrooms do you have?

Professional license records 340 generally include information related to an individual's professional license. For example, doctors, nurses, social workers, lawyers, CPAs, insurance agents, real estate agents, stock brokers, teachers, electricians, plumbers, and hair dressers may all have a professional license to engage in their trade. The information generally includes, the profession, the license type, license number, name of the individual holding the license, the status of the license, issue date, an address associated with the license, as well as any discipline information. Some exemplary questions include: Are you licensed? and What are you licensed for?

Election contribution records 345 include information relating to an individual's political contributions. For example, the information may include the name of the contributor, a city, state, and zip of the contributor, the date and amount of the contribution, a title associated with the contributor, as well as the name of the party receiving the contribution. Some exemplary questions include: Have you made a political contribution within the last six months? Who received the contribution? and How much was the contribution?

Criminal records 350 include information associated with a criminal record. For example, the record may include the name of the criminal, a birth date, the sex of the criminal, offense information, the sentence length, the date of the crime, and the type of crime. Exemplary questions, include: Do you have a criminal record? When did the crime occur? and what was the type of crime?

Marriage/divorce records 355 generally include information relating to the marriage and divorce of a couple. The marriage records generally include the name of the bride and groom, the date of the wedding, the county and state of the wedding, and the age of the individuals. The divorce records generally include the names of the divorcing parties, the minors of the divorcing parties, and the date of the divorce. Some exemplary questions include: Have you ever been married? Who are you married too? What is your maiden name? Where did you get married? Are you divorced? How many minors were in the house when the divorce occurred? and What year did you get divorced?

Civil judgment records 360 generally include any civil judgment information against an individual. This information may include the type of judgment, the amount of the judgment, and the parties involved in the judgment. Exemplary questions that may be asked based on these records include: Is there a judgment against you? If so, what was the judgment amount? and What is the year of the judgment?

Secretary of State Records 365 generally include information relating to registered companies within a state. The records may include a registered agent name, the name of the company, the type of the company, and an address. Exemplary questions may include: Where do you work? and What is the work's address?

Other public records 370 may be any public records that assist in verification of a consumer. Appropriate questions may be generated based on the public records that are accessed.

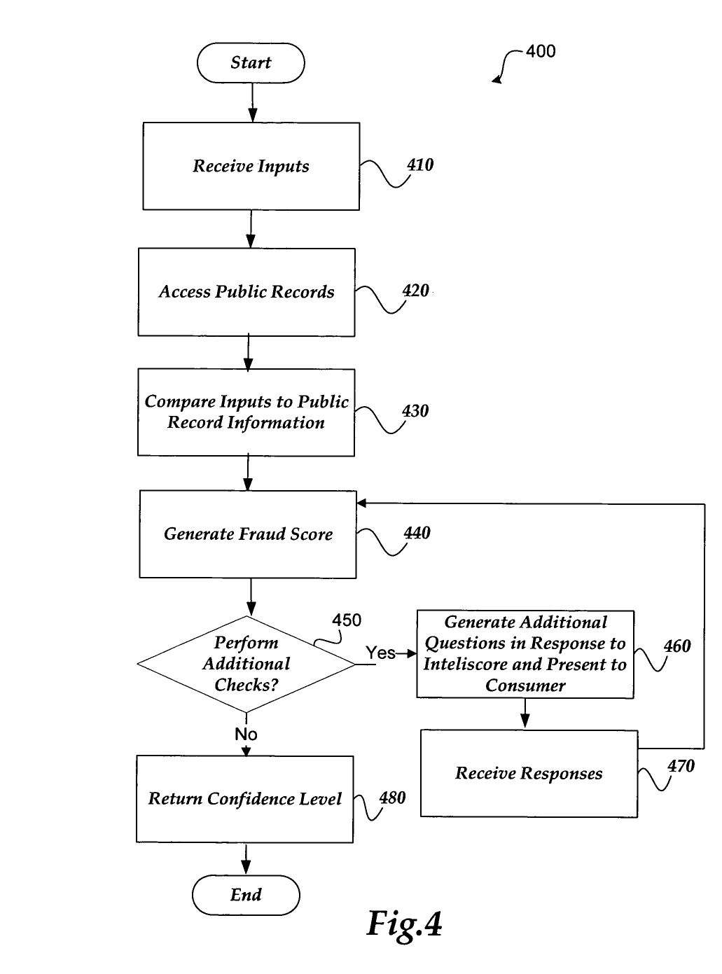

FIG. 4 shows a process for detecting fraud and verifying a consumer using public records, in accordance with aspects of the invention.

After a start block, the process flows to block 410 where inputs are received to begin the verification process. The inputs are selected based on the relationship between the verifying entity and the consumer. For example, the relationship may be a purchase of an item or service, or a verification system to enter a more secure area. The inputs may include a variety of data, including: credit card information, billing address; user address; shipping address; and for online transactions: remote IP address, browser information, email address, and the like. According to one embodiment, the inputs include the consumer's credit card number, billing address, home address, shipping address, remote IP address, email address, address verification system (AVS), credit card verification system (CVV), and user verification data. The AVS and CVV information is obtained from the appropriate systems. Other inputs may also be used. According to one embodiment, at least the billing address and credit card number is obtained from the consumer.

The credit card number's first six digits for Visa and MasterCard may be used to determine what bank issued card as well as the country of the bank.

For online transactions, additional online inputs may be obtained. For example, the remote IP address, email address, and browser information may be obtained. The remote IP address may be used to identify the area such as the country or state/region where the consumer is connecting to the network from. The remote IP address may also be compared to lists of proxies or anonymizers to determine if the address is valid.

The inputs from the browser may include items such as the operating system being used on the client device, the browser type, the language, the time zone, as well as the local time. The time on the consumer's computer may be matched to what the time should be based on the provided address. For example, if the user claims to be from a city on the West coast of the United States, the time from their computer should match this time zone.

The email address may be used to aid in determining whether the consumer is authenticating by determining whether or not the email is valid. For example, an email could be validated by sending a message asking for a reply enclosing a key, or whether the domain name is a valid DNS or whether it is an unknown host.

The remote IP address may be used to obtain country information or region information associated with the computer. A check can be made to determine if there is there a reverse DNS entry or not. If the consumer is a fraudster there may not be a reverse DNS entry. The remote IP address may also be compared against known lists of anonymizers. The remote IP address may also be compared against a list of good addresses.

Moving to block 420, public records are accessed. According to one embodiment, the AVS records, and CVV records are accessed when the CVV number is provided by the consumer.

Transitioning to block 430 the inputs received from the user and the public record sources are compared against the data found in the public records. For example, do the addresses match? For example, for an online transaction, does the remote IP address indicate the same region where is the bank located?

Flowing to block 440, a fraud score is generated based on the comparisons and scoring associated with the matching. Generally, the fraud score is based on the number of matches between the address inputs.

Transitioning to decision block 450, a determination is made as to whether to perform any additional checks. Additional checks may be performed for many different reasons. Some of these reasons may be based on a verification level set by the verifying entity. For example, a consumer attempting to purchase a very expensive item may be verified at a much higher level than a person buying an MP3. The verifying entity may assign a verification level such as low, medium, or high and based on the verification level and returned fraud score a decision may be made to perform additional checks. The combination of the fraud score and the verification level is used in determining the difficulty of the questions to answer.

When additional checks are to be performed, the process moves to block 460, where additional questions are generated and presented to the consumer. The questions generally ask for out of wallet information that only the true individual should now. For example, in 1996, who where you living with? What is your anniversary? What year was you divorce? What is your wife's maiden name?

The public records accessed to generate the questions and answers to the questions depend on the difficulty of questions desired. For example, according to one embodiment, difficult questions are selected from the social security records and DMV records. Medium difficulty questions are generated from a public records directory, property data, civil judgment records, criminal records, marriage/divorce records, and birth/death records. Easy questions may access professional license records, AVS records, and CVV records. No matter what difficulty is desired, however, any public record source may be used to generate the appropriate difficulty level question. The public records may include any available public records, including, but not limited to the public record sources shown in FIG. 3.

For example, additional questions may be something like: Which of these individuals is your neighbor? Is there a judgment against you? Have you been divorced? Do you hold any licenses? What is your mortgage payment? What are the last four digits of your social security number? Who lives in the house with you? What is your address history? Who are your roommates? What city was this in? and the like.

Moving to block 470, the responses to the questions are received from the user. The responses may be received from the consumer in many different ways. For example, the consumer may provide responses over a wireless device, a computer, in person, or over the phone.

The process then returns to block 440, where the fraud score is updated.

When there are not additional checks to perform, the process transitions to block 480 where the confidence level associated with the user is returned to the verifying entity. The process then moves to an end block.

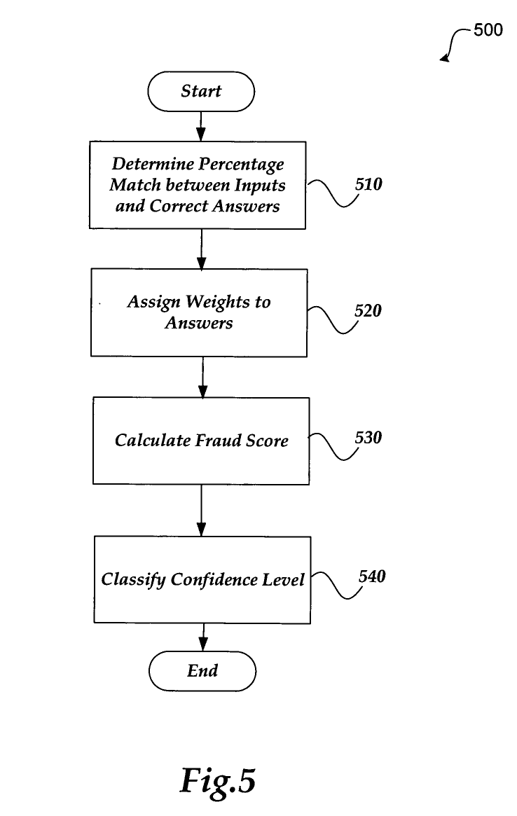

FIG. 5 shows a process for calculating a fraud score and confidence level, in accordance with aspects of the invention. After a start block, the process flows to block 510, where a determination is made as to the percentage match between the inputs and correct answers. For example, when all of the countries match then the score remains perfect.

Flowing to block 520, weights are assigned to the answers. Some answers may be assigned higher or lower weighting values thereby affecting the fraud score. For example, if a consumer incorrectly answers a question about their neighbor, this may not count as much against them as not knowing who lives in their house with them. Additionally, some countries may be classified as higher risk based on problems within those countries.

Transitioning to block 530, the fraud score is calculated. According to one embodiment, the fraud score is calculated by adding the weights of all the answers. Any method of calculating the fraud score may be used. For example, the fraud score could be calculated by merely counting the number of correct answers and subtracting the number of incorrect answers.

Moving to block 540, the fraud score is used to classify the confidence level of the verification. According to one embodiment, the fraud score is used to categorize the risk as low, medium, and high. The process then moves to an end block.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for detecting fraud and verifying a consumer, comprising:
receiving input associated with the consumer;
generating a fraud score;
determining whether to perform additional verification in response to the fraud score; and
accessing public records in real-time to generate questions for the consumer when it has been determined to perform additional verification; and updating the fraud score based the response to the verification questions.

2. The method of claim 1, wherein receiving the input further comprises receiving addresses associated with a credit card and the consumer.

3. The method of claim 2, wherein accessing the public records further comprises accessing at least one of the following public record sources: address verification system (AVS) records; credit card verification system (CVV) records; death records; department of motor vehicle (DMV) records; social security records; property records; professional records; election contribution records; criminal records;
marriage/divorce records; civil judgment records; and Secretary of State records.

4. The method of claim 3, wherein accessing the public records in real-time to generate the questions for the consumer, further comprises accessing different public record sources depending on a verification level associated with the consumer.

5. The method of claim 4, wherein receiving the input further comprises receiving online input information for online verification including at least one of the following inputs: a remote IP address associated with a device the consumer is using to access a network; an email address associated with the consumer, and browser information associated with the device.

6. The method of claim 3, wherein accessing the public records in real-time to generate the questions for the consumer further comprises generating the questions such that the questions ask for out-of-wallet information associated with the user.

7. The method of claim 3, wherein generating the fraud score further comprises assigning values to the responses and adding the values of the responses to generate the fraud score.

8. A system for detecting fraud and verifying a consumer, comprising:
a first computing device coupled to a network and, including:
a processor and a computer-readable medium;
an operating environment stored on the computer-readable medium and executing on the processor;
a communication connection device operating under the control of the operating environment; and
a verification application operating under the control of the operating environment and operative to perform actions, including:
receiving input associated with the consumer;
accessing public records;
generating a fraud score;
determining whether to perform additional verification;
and when it has been determined to perform the additional verification, accessing the public records in real-time to generate questions for the consumer; and updating the fraud score based the response to the verification questions; and
a second computing device coupled to the network and the first computing device and that include an application configured to send the response to the verification questions to the first computing device and receive the fraud score generated by the first computing device.

9. A computer-readable medium having computer instructions for detecting fraud and verifying a consumer, the instructions comprising:
receiving input associated with the consumer;
associating public records in real-time;
generating a fraud score;
determining whether to perform additional verification in response to the fraud score; and when it has been determined to perform additional verification:
generating questions for the consumer; and
updating the fraud score based the response to the verification questions.
